(19) United States
(12) Patent Application Publication
(10) Pub. No.: US 2015/0262112 A1
(43) Pub. Date: Sep. 17, 2015

(54) MONITORING SYSTEM AND METHOD

(71) Applicant: Matthew Raanan, Los Angeles, CA (US)

(72) Inventor: Matthew Raanan, Los Angeles, CA (US)

(21) Appl. No.: 14/204,093

(22) Filed: Mar. 11, 2014

(51) Int. Cl. G06Q 10/06; H04W 4/02

(52) U.S. Cl. CPC G06Q 10/063114; H04W 4/02

(57) ABSTRACT

A monitoring system and method that enables a manager to monitor a mobile employee carrying a communication device. The exact location and time worked by the employee while performing the job helps the manager formulate compensation. The communication device includes a smart phone having a positioning system and a camera for the manager to view and track the employee while performing the job. The manager downloads a positioning system, such as a global positioning system, into a communication device. The employee carries the communication device in proximity while performing a job. The manager sets parameters for the employee and the job. The parameters include location, and at what durations the employee works. The manager is alerted if the employee works outside the parameters.

### RELATED CO-PENDING U.S. PATENT APPLICATIONS

The following related U.S. patent application(s), submitted by at least one of the present Applicant(s)/Inventor(s) is/(are) recently co-pending: U.S. Utility patent application Ser. No. 14/203,941, entitled “Management System and Method”, and submitted to the United States Patent and Trademark Office (USPTO) on Mar. 11, 2013.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### FIELD OF THE INVENTION

One or more embodiments of the invention generally relate to a monitoring system and method. More particularly, one or more embodiments of the invention relate to a monitoring system and method that enables a manager to monitor an employee through a positioning system.

### BACKGROUND OF THE INVENTION

The following background information may present examples of specific aspects of the prior art (e.g., without limitation, approaches, facts, or common wisdom) that, while expected to be helpful to further educate the reader as to additional aspects of the prior art, is not to be construed as limiting the present invention, or any embodiments thereof, to anything stated or implied therein or inferred thereupon.

The following is an example of a specific aspect in the prior art that, while expected to be helpful to further educate the reader as to additional aspects of the prior art, is not to be construed as limiting the present invention, or any embodiments thereof, to anything stated or implied therein or inferred thereupon. By way of educational background, another aspect of the prior art generally useful to be aware of is that a positioning system is a mechanism for determining the location of an object in space. Technologies for this task exist ranging from worldwide coverage with meter accuracy to workspace coverage with sub-millimeter accuracy.

It is known that a global positioning system allows specialized radio receivers to determine their 3-D space position, as well as time, with an accuracy of 2-20 meters or tens of nanoseconds. Currently deployed systems use microwave signals that can only be received reliably outdoors and that cover most of Earth's surface, as well as near-Earth space. The global positioning system is precise enough to detect the location of an object in an office space or smaller.

Often, a salary is a pay or wage earned for a duration of work. The salary may be based on hours worked, projects completed, or simply a salary for coming to the job site at predetermined hours and days. Typically though, the salary is involves a periodic payment from an employer to an employee, which may be specified in an employment contract. It is contrasted with piece wages, where each job, hour or other unit is paid separately, rather than on a periodic basis.

Typically, in an organization, the payroll is the sum of all financial records of salaries for an employee, wages, bonuses and deductions. In accounting, payroll refers to the amount paid to employees for services they provided during a certain period of time. Payroll is determined by duration worked, time off, taxes, and salary ranges.

Many organizations today employ various types of systems, such as time management systems, personnel management systems, accounting systems and the like to maintain and track resources within the organization. Of particular concern is the tracking of employee performance statistics, such as absenteeism. Another concern is verifying that the employee is in a work space performing a job duty, as required.

In view of the foregoing, it is clear that these traditional techniques are not perfect and leave room for more optimal approaches.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 illustrates a flowchart diagram of the steps for an exemplary monitoring method, in accordance with an embodiment of the present invention;

FIG. 2 illustrates a diagrammatic view of an exemplary monitoring system monitoring a location of an employee with an exemplary positioning system, in accordance with an embodiment of the present invention;

FIG. 3 illustrates a system block diagram for an exemplary monitoring system, in accordance with an embodiment of the present invention; and

FIG. 4 illustrates a typical computer system that, when appropriately configured or designed, can serve as an exemplary management system and method for a manager to manage an employee, in accordance with an embodiment of the present invention.

Unless otherwise indicated illustrations in the figures are not necessarily drawn to scale.

### DETAILED DESCRIPTION OF SOME EMBODIMENTS

Embodiments of the present invention are best understood by reference to the detailed figures and description set forth herein.

Embodiments of the invention are discussed below with reference to the Figures. However, those skilled in the art will readily appreciate that the detailed description given herein with respect to these figures is for explanatory purposes as the invention extends beyond these limited embodiments. For example, it should be appreciated that those skilled in the art will, in light of the teachings of the present invention, recognize a multiplicity of alternate and suitable approaches, depending upon the needs of the particular application, to implement the functionality of any given detail described herein, beyond the particular implementation choices in the following embodiments described and shown. That is, there are numerous modifications and variations of the invention that are too numerous to be listed but that all fit within the scope of the invention. Also, singular words should be read as plural and vice versa and masculine as feminine and vice versa, where appropriate, and alternative embodiments do not necessarily imply that the two are mutually exclusive.

It is to be further understood that the present invention is not limited to the particular methodology, compounds, materials, manufacturing techniques, uses, and applications, described herein, as these may vary. It is also to be understood that the terminology used herein is used for the purpose of describing particular embodiments only, and is not intended to limit the scope of the present invention. It must be noted that as used herein and in the appended claims, the singular forms “a,” “an,” and “the” include the plural reference unless the context clearly dictates otherwise. Thus, for example, a reference to “an element” is a reference to one or more elements and includes equivalents thereof known to those skilled in the art. Similarly, for another example, a reference to “a step” or “a means” is a reference to one or more steps or means and may include sub-steps and subservient means. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

Unless defined otherwise, all technical and scientific terms used herein have the same meanings as commonly understood by one of ordinary skill in the art to which this invention belongs. Preferred methods, techniques, devices, and materials are described, although any methods, techniques, devices, or materials similar or equivalent to those described herein may be used in the practice or testing of the present invention. Structures described herein are to be understood also to refer to functional equivalents of such structures. The present invention will now be described in detail with reference to embodiments thereof as illustrated in the accompanying drawings.

From reading the present disclosure, other variations and modifications will be apparent to persons skilled in the art. Such variations and modifications may involve equivalent and other features which are already known in the art, and which may be used instead of or in addition to features already described herein.

Although Claims have been formulated in this application to particular combinations of features, it should be understood that the scope of the disclosure of the present invention also includes any novel feature or any novel combination of features disclosed herein either explicitly or implicitly or any generalization thereof, whether or not it relates to the same invention as presently claimed in any Claim and whether or not it mitigates any or all of the same technical problems as does the present invention.

Features which are described in the context of separate embodiments may also be provided in combination in a single embodiment. Conversely, various features which are, for brevity, described in the context of a single embodiment, may also be provided separately or in any suitable subcombination. The Applicants hereby give notice that new Claims may be formulated to such features and/or combinations of such features during the prosecution of the present application or of any further Application derived therefrom.

References to “one embodiment,” “an embodiment,” “example embodiment,” “various embodiments,” etc., may indicate that the embodiment(s) of the invention so described may include a particular feature, structure, or characteristic, but not every embodiment necessarily includes the particular feature, structure, or characteristic. Further, repeated use of the phrase “in one embodiment,” or “in an exemplary embodiment,” do not necessarily refer to the same embodiment, although they may.

As is well known to those skilled in the art many careful considerations and compromises typically must be made when designing for the optimal manufacture of a commercial implementation any system, and in particular, the embodiments of the present invention. A commercial implementation in accordance with the spirit and teachings of the present invention may configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

In the following description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still cooperate or interact with each other.

A “computer” may refer to one or more apparatus and/or one or more systems that are capable of accepting a structured input, processing the structured input according to prescribed rules, and producing results of the processing as output. Examples of a computer may include: a computer; a stationary and/or portable computer; a computer having a single processor, multiple processors, or multi-core processors, which may operate in parallel and/or not in parallel; a general purpose computer; a supercomputer; a mainframe; a super mini-computer; a mini-computer; a workstation; a micro-computer; a server; a client; an interactive television; a web appliance; a telecommunications device with internet access; a hybrid combination of a computer and an interactive television; a portable computer; a tablet personal computer (PC); a personal digital assistant (PDA); a portable telephone; application-specific hardware to emulate a computer and/or software, such as, for example, a digital signal processor (DSP), a field-programmable gate array (FPGA), an application specific integrated circuit (ASIC), an application specific instruction-set processor (ASIP), a chip, chips, a system on a chip, or a chip set; a data acquisition device; an optical computer; a quantum computer; a biological computer; and generally, an apparatus that may accept data, process data according to one or more stored software programs, generate results, and typically include input, output, storage, arithmetic, logic, and control units.

Those of skill in the art will appreciate that where appropriate, some embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Where appropriate, embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

“Software” may refer to prescribed rules to operate a computer. Examples of software may include: code segments in one or more computer-readable languages; graphical and or/textual instructions; applets; pre-compiled code; interpreted code; compiled code; and computer programs.

The example embodiments described herein can be implemented in an operating environment comprising computer-executable instructions (e.g., software) installed on a computer, in hardware, or in a combination of software and hardware. The computer-executable instructions can be written in a computer programming language or can be embodied in firmware logic. If written in a programming language conforming to a recognized standard, such instructions can be executed on a variety of hardware platforms and for interfaces to a variety of operating systems. Although not limited thereto, computer software program code for carrying out operations for aspects of the present invention can be written in any combination of one or more suitable programming languages, including an object oriented programming languages and/or conventional procedural programming languages, and/or programming languages such as, for example, Hyper text Markup Language (HTML), Dynamic HTML, Extensible Markup Language (XML), Extensible Stylesheet Language (XSL), Document Style Semantics and Specification Language (DSSSL), Cascading Style Sheets (CSS), Synchronized Multimedia Integration Language (SMIL), Wireless Markup Language (WML), Java™, Jini™, C, C++, Smalltalk, Perl, UNIX Shell, Visual Basic or Visual Basic Script, Virtual Reality Markup Language (VRML), ColdFusion™ or other compilers, assemblers, interpreters or other computer languages or platforms.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

A network is a collection of links and nodes (e.g., multiple computers and/or other devices connected together) arranged so that information may be passed from one part of the network to another over multiple links and through various nodes. Examples of networks include the Internet, the public switched telephone network, the global Telex network, computer networks (e.g., an intranet, an extranet, a local-area network, or a wide-area network), wired networks, and wireless networks.

The Internet is a worldwide network of computers and computer networks arranged to allow the easy and robust exchange of information between computer users. Hundreds of millions of people around the world have access to computers connected to the Internet via Internet Service Providers (ISPs). Content providers (e.g., website owners or operators) place multimedia information (e.g., text, graphics, audio, video, animation, and other forms of data) at specific locations on the Internet referred to as webpages. Websites comprise a collection of connected, or otherwise related, webpages. The combination of all the websites and their corresponding webpages on the Internet is generally known as the World Wide Web (WWW) or simply the Web.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The flowchart and block diagrams in the figures illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

Further, although process steps, method steps, algorithms or the like may be described in a sequential order, such processes, methods and algorithms may be configured to work in alternate orders. In other words, any sequence or order of steps that may be described does not necessarily indicate a requirement that the steps be performed in that order. The steps of processes described herein may be performed in any order practical. Further, some steps may be performed simultaneously.

It will be readily apparent that the various methods and algorithms described herein may be implemented by, e.g., appropriately programmed general purpose computers and computing devices. Typically a processor (e.g., a microprocessor) will receive instructions from a memory or like device, and execute those instructions, thereby performing a process defined by those instructions. Further, programs that implement such methods and algorithms may be stored and transmitted using a variety of known media.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The functionality and/or the features of a device may be alternatively embodied by one or more other devices which are not explicitly described as having such functionality/features. Thus, other embodiments of the present invention need not include the device itself.

The term “computer-readable medium” as used herein refers to any medium that participates in providing data (e.g., instructions) which may be read by a computer, a processor or a like device. Such a medium may take many forms, including but not limited to, non-volatile media, volatile media, and transmission media. Non-volatile media include, for example, optical or magnetic disks and other persistent memory. Volatile media include dynamic random access memory (DRAM), which typically constitutes the main memory. Transmission media include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a processor. For example, sequences of instruction (i) may be delivered from RAM to a processor, (ii) may be carried over a wireless transmission medium, and/or (iii) may be formatted according to numerous formats, standards or protocols, such as Bluetooth, TDMA, CDMA, 3G.

Where databases are described, it will be understood by one of ordinary skill in the art that (i) alternative database structures to those described may be readily employed, (ii) other memory structures besides databases may be readily employed. Any schematic illustrations and accompanying descriptions of any sample databases presented herein are exemplary arrangements for stored representations of information. Any number of other arrangements may be employed besides those suggested by the tables shown. Similarly, any illustrated entries of the databases represent exemplary information only; those skilled in the art will understand that the number and content of the entries can be different from those illustrated herein. Further, despite any depiction of the databases as tables, an object-based model could be used to store and manipulate the data types of the present invention and likewise, object methods or behaviors can be used to implement the processes of the present invention.

A “computer system” may refer to a system having one or more computers, where each computer may include a computer-readable medium embodying software to operate the computer or one or more of its components. Examples of a computer system may include: a distributed computer system for processing information via computer systems linked by a network; two or more computer systems connected together via a network for transmitting and/or receiving information between the computer systems; a computer system including two or more processors within a single computer; and one or more apparatuses and/or one or more systems that may accept data, may process data in accordance with one or more stored software programs, may generate results, and typically may include input, output, storage, arithmetic, logic, and control units.

A “network” may refer to a number of computers and associated devices that may be connected by communication facilities. A network may involve permanent connections such as cables or temporary connections such as those made through telephone or other communication links. A network may further include hard-wired connections (e.g., coaxial cable, twisted pair, optical fiber, waveguides, etc.) and/or wireless connections (e.g., radio frequency waveforms, free-space optical waveforms, acoustic waveforms, etc.). Examples of a network may include: an internet, such as the Internet; an intranet; a local area network (LAN); a wide area network (WAN); and a combination of networks, such as an internet and an intranet.

As used herein, the “client-side” application should be broadly construed to refer to an application, a page associated with that application, or some other resource or function invoked by a client-side request to the application. A “browser” as used herein is not intended to refer to any specific browser (e.g., Internet Explorer, Safari, FireFox, or the like), but should be broadly construed to refer to any client-side rendering engine that can access and display Internet-accessible resources. A “rich” client typically refers to a non-HTTP based client-side application, such as an SSH or CFIS client. Further, while typically the client-server interactions occur using HTTP, this is not a limitation either. The client server interaction may be formatted to conform to the Simple Object Access Protocol (SOAP) and travel over HTTP (over the public Internet), FTP, or any other reliable transport mechanism (such as IBM® MQSeries® technologies and CORBA, for transport over an enterprise intranet) may be used. Any application or functionality described herein may be implemented as native code, by providing hooks into another application, by facilitating use of the mechanism as a plug-in, by linking to the mechanism, and the like.

Exemplary networks may operate with any of a number of protocols, such as Internet protocol (IP), asynchronous transfer mode (ATM), and/or synchronous optical network (SONET), user datagram protocol (UDP), IEEE 402.x, etc.

Embodiments of the present invention may include apparatuses for performing the operations disclosed herein. An apparatus may be specially constructed for the desired purposes, or it may comprise a general-purpose device selectively activated or reconfigured by a program stored in the device.

Embodiments of the invention may also be implemented in one or a combination of hardware, firmware, and software. They may be implemented as instructions stored on a machine-readable medium, which may be read and executed by a computing platform to perform the operations described herein.

More specifically, as will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

In the following description and claims, the terms “computer program medium” and “computer readable medium” may be used to generally refer to media such as, but not limited to, removable storage drives, a hard disk installed in hard disk drive, and the like. These computer program products may provide software to a computer system. Embodiments of the invention may be directed to such computer program products.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Unless specifically stated otherwise, and as may be apparent from the following description and claims, it should be appreciated that throughout the specification descriptions utilizing terms such as “processing,” “computing,” “calculating,” “determining,” or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In a similar manner, the term “processor” may refer to any device or portion of a device that processes electronic data from registers and/or memory to transform that electronic data into other electronic data that may be stored in registers and/or memory. A “computing platform” may comprise one or more processors.

Embodiments within the scope of the present disclosure may also include tangible and/or non-transitory computer-readable storage media for carrying or having computer-executable instructions or data structures stored thereon. Such non-transitory computer-readable storage media can be any available media that can be accessed by a general purpose or special purpose computer, including the functional design of any special purpose processor as discussed above. By way of example, and not limitation, such non-transitory computer-readable media can include RAM, ROM, EEPROM, CD-ROM or other optical disk storage, magnetic disk storage or other magnetic storage devices, or any other medium which can be used to carry or store desired program code means in the form of computer-executable instructions, data structures, or processor chip design. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

While a non-transitory computer readable medium includes, but is not limited to, a hard drive, compact disc, flash memory, volatile memory, random access memory, magnetic memory, optical memory, semiconductor based memory, phase change memory, optical memory, periodically refreshed memory, and the like; the non-transitory computer readable medium, however, does not include a pure transitory signal per se; i.e., where the medium itself is transitory.

The present invention will now be described in detail with reference to embodiments thereof as illustrated in the accompanying drawings.

There are various types of systems and methods for monitoring a mobile employee with a positioning system. The system and method may enable a manager to monitor a mobile employee carrying a communication device. The exact location of the employee at various hours of the work day may help the manager formulate a compensation for the employee. The communication device may include a smart phone having a positioning system and a camera for the manager to view and track the employee while performing the job.

In one embodiment, the manager may integrate or download a positioning system, such as a global positioning system, into a communication device utilized by the employee. The employee may carry the communication device or retain the communication device in proximity while performing a job. The employee may utilize the communication device for logging in and out of the job. The manager may monitor the employee through the communication device during the duration of the job, such as business hours. The manager may download software that monitors the positioning system. The software can record live or may record random short clips. In some instances the software may take still pictures of the employee. In typical use, the employee places the communication device in their workspace where they can be monitored or watched. The information gathered by the communication device may then be uploaded to the server. It is contemplated that the camera light on the communication device may be on or off while recording, and that the software may disable the camera light so that the employee does not know when the device is recording. In some embodiments, the software may use facial recognition to determine if the employee is at their workspace and can notify the manager of this status.

In some embodiments, the manager may set at least one parameters for the employee and the job through software that monitors and regulates the communication device. The at least one parameter may be useful in helping the manager monitor the employee and the job by forming a parameter, such as, at which location, and at what durations the employee may perform the job. For example, without limitation, the at least one parameter may dictate that the employee be within one hundred meters of the job site to log in and begin working. In another example, the manager may be alerted if the employee performs an event, such as leaving the job site without authorization. The parameters may also require that the employee check in with the manager manually or automatically. In this manner, the manager may have better control over the employee and the job, including compensation and payroll decisions, whereby the manager receives an accurate depiction of hours worked and breaks taken by the employee.

In some embodiments, the system and method may enable the manager to view an image of an employee performing the job through a camera in the communication device. From the image, the manager may form a better understanding of the job status, such as progress, problems, duration, and events related to the job. The image may include, without limitation, a live feed, a recorded video, or a snap shot. The image may also record areas that are related to the job.

In some embodiments, the system and method may enable the manager to track the location of the employee, since the communication device is in proximity to the employee while performing the job. The communication device may include an installed positioning system, such as a global positioning system, for indicating the location of the communication device. In this manner, when the employee remains in proximity to the communication device during the job, and the manager can monitor when the employee is working on the processing device, or when the employee is in a different location. In one embodiment, the positioning system may help resolve payroll issues by monitoring the amount of hours worked and the amount of breaks taken by the employee. In this manner, an accurate compensation may be derived for the employee.

In some embodiments, the positioning system may enable the communication device to better communicate with the manager regarding the duration of the job, and performance indicators for the job. The employee may initially log in to the system such that the manager may monitor the employee. From this logged in monitoring configuration, the location of the employee and the job duration are recorded in the system for calculating compensation and better understanding the status of the job.

The communication device may alert the manager if the employee is not conforming to the at least one parameter, such as, location movement by the employee, hours worked, time when breaks are taken, overtime requests, expenses endured for the job, success or failure of the job, and scheduling related requests. The manager may transmit information and requests to the communication device of the employee. In some embodiments, the duration of the job and the at least one event may be utilized by the manager to calculate compensation for the employee. Additionally, this information may be efficacious for managing a job at a remote location where the manager cannot be in person.

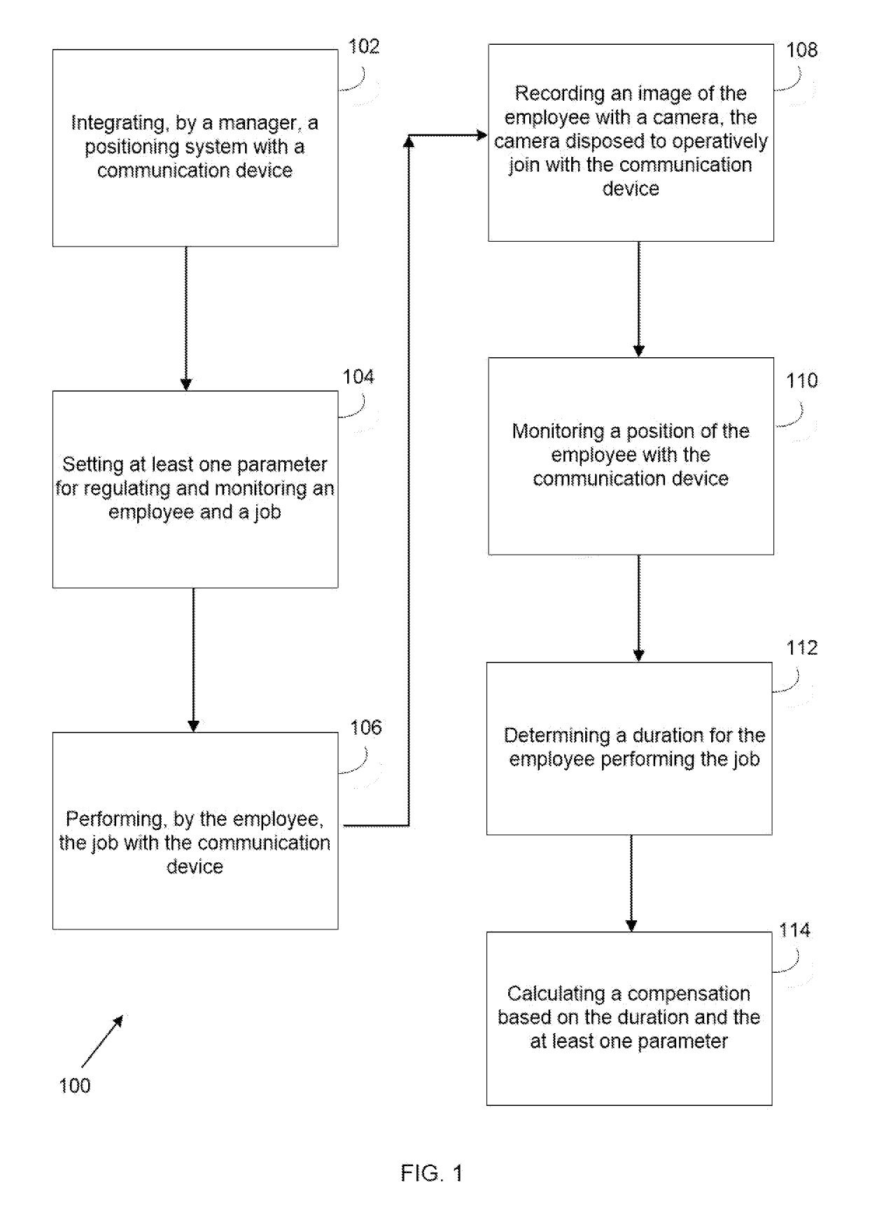

FIG. 1 illustrates a flowchart diagram of the steps for an exemplary management method, in accordance with an embodiment of the present invention. In the present invention, a monitoring method 100 may enable a manager to monitor a mobile employee carrying a communication device. The exact location of the employee at various hours of the work day may help the manager formulate a compensation for the employee. The communication device may include a communication device, such as a smart phone having a positioning system and a camera for the manager to view and track the employee while performing the job.

In some embodiments, the method may enable the manager to set at least one parameter to regulate the employee and the job. The method is efficacious for helping the manager to accurately understand the status of a job and an employee. In this manner, the manager may assess job performance and compensation for the employee, even while not being personally present at the job site.

The method may include an initial Step 102 of integrating, by a manager, a positioning system into a communication device. The manager may, in one embodiment, download software onto a processing device that operatively connects with the positioning system in the communication device. The positioning system may utilize positioning technology to determine the location of the employee in relation to the job site and the manager. Those skilled in the art will recognize that positioning technologies may range from worldwide coverage with meter accuracy to workspace coverage with sub-millimeter accuracy. The positioning system may include, without limitation, a global positioning system, a radio frequency triangulation system, Wii Remote with Sensor Bar, Polhemus Tracker, Precision Motion Tracking Solutions InterSense, Galileo, and Active Bat.

In some embodiments, the manager may initially download the positioning system onto the communication device at a remote location. The communication device may be utilized by the employee to perform the job. The communication device may be joined with a camera for recording an image of the employee and the job site. In some embodiments, the software utilized by the manager may provide a graphical interface that enables the manager to view the employee and job information from a processing device, such as computer, a smart phone, or any number of technological devices. In some embodiments, the positioning system software may track the employee by camera, global positioning system, and short clips of video recording what the employee is doing at any moment.

The manager may be in a position to monitor the communication device, and thereby the employee. The manager may include a business executive who oversees an organization's marketing and sales functions, as well as the day-to-day business operations. However in other embodiments, the manager may include, without limitation, a project manager, a general manger, a sports manager, and a talent manager. The manager may include a business executive who oversees an organization's marketing and sales functions, as well as the day-to-day business operations. However in other embodiments, the manager may include, without limitation, a project manager, a general manger, a sports manager, and a talent manager.

The method may further comprise a Step 104 of setting, by the manager, at least one parameter for regulating and monitoring the employee and the job. In some embodiments, the manager may create at least one parameter 216 that sets a dictate for the employee. The parameter may be efficacious in monitoring and regulating the employee and the manner by which the employee performs the job. The at least one parameter may be useful in helping the manager monitor the employee and the job by forming a parameter, such as, location, and work durations the employee may perform on the job. The communication device may be integrated with the parameter, such that the software in the communication device may at least partially restrict the employee from performing certain functions if the parameters have been crossed. For example, without limitation, if the parameter set by the manager requires the employee to perform the job within 20 meters of a work station, the communication device may log the employee off, and cease functioning if the employee moves beyond the 20 meters. The manager may also receive an alert. In another example, the parameter may restrict the employee from logging off the system prior to a 5:00 pm closing time. The communication device may generate an audible signal if the employee attempts to log off prior to 5:00 pm.

In some embodiments, the manager may set at least one parameters for the employee and the job through the positioning system software that monitors and regulates the communication device. The at least one parameter may be useful in helping the manager monitor the employee and the job by forming a parameter, such as, at which location, and at what durations the employee may perform the job. For example, without limitation, the at least one parameter may dictate that the employee be within one hundred meters of the job site to log in and begin working. In another example, the manager may be alerted if the employee performs an event, such as leaving the job site without authorization. The parameters may also require that the employee check in with the manager manually or automatically. In this manner, the manager may have better control over the employee and the job, including compensation and payroll decisions, whereby the manager receives an accurate depiction of hours worked and breaks taken by the employee.

In some embodiments, a Step 106 may include performing, by an employee, a job on the communication device at a remote location. The remote location may include a work station at a different geographical location than the manager. In some embodiments, the communication device may include a smart phone used by the employee to at least partially perform the job. The communication device may include, without limitation, a smart phone, a two-way radio, a cellular phone, a fax machine, a laptop, a computer, a tablet, and a vehicle. The communication device of the employee may include the camera, whereby the employee may be visually monitored. The communication device may also be operatively joined with the manager's processing device.

A Step 108 may include recording an image of the employee with a camera on the communication device. The camera may include a smartphone camera that orients to face the employee at the work station. In some embodiments, the employee may be required to face the camera in proximity to the work station. In other embodiments, additional cameras from the website may work in conjunction with the camera on the communication device to record images of the employee and the web site. In this manner, the employee may be directly observed by the manager while performing functions in proximity to the communication device. In one embodiment, the observed functions may be monitored by the software downloaded by the manager. The performed functions may include an image of the employee working, log in and off status for the employee, keys typed on a keyboard, websites visited from the processing device, and telephone communications by the employee. The recorded image may include, without limitation, a live feed, a recorded video, or a snap shot of the employee working on the processing device and the job site. The image may also record areas that are related to the job.

In some embodiments, a Step 110 may comprise monitoring a location of the employee with the communication device. The location of the employee may be observed and regulated by the manager to determine whether the employee is performing the job at the work station, and at what stage the employee is in completing the job. In some embodiments, the system and method may enable the manager to track the location of the employee through a communication device that is in proximity to the employee while performing the job.

The communication device may include an installed positioning system, such as a global positioning system, for indicating the location of the communication device. In this manner, the employee remains in proximity to the communication device during the job, and the manager can monitor when the employee is working at a work station, or when the employee is in a different location. Additional information may be derived by approximating the location of the employee.

A Step 112 includes determining a duration for the employee performing the job. The duration may include the number of hours or days worked by the employee. The communication device may monitor when the employee logs in and out for the job, and also indicates breaks taken during the duration. This information may at least partially dictate compensation for the employee. In some embodiments, the manager may regulate the duration of the job by sending dictates to the employee to continue working, or to cease working. The manager may also approximate the remainder duration of the job by monitoring the employee and the job.

Those skilled in the art will recognize that the positioning system may utilize software that monitors the duration of work by the employee. The software may also monitor and report the location of the employee. By monitoring the data and setting parameters in response to the data, the manager may better regulate the time allotment and specific job duties performed by the employee. For example, without limitation, the employee could be alerted if a lunch break is too long. The employee could also be notified by the manager to switch job tasks at a certain time of day if the communication device is remaining in a stationary location for a duration.

A final Step 114 includes calculating a compensation based on the duration of the job and the location of the employee performing the job. In some embodiments, the duration of the job may be utilized by the manager to calculate compensation for the employee. Additionally, this information may be efficacious for managing a job at a remote location where the manager cannot be in person. Those skilled in the art will recognize that the monitoring method may be efficacious in managing a website company, where most of the employees work remotely. The manager may better justify compensation to the employee based on visual verification of work performed on the job.

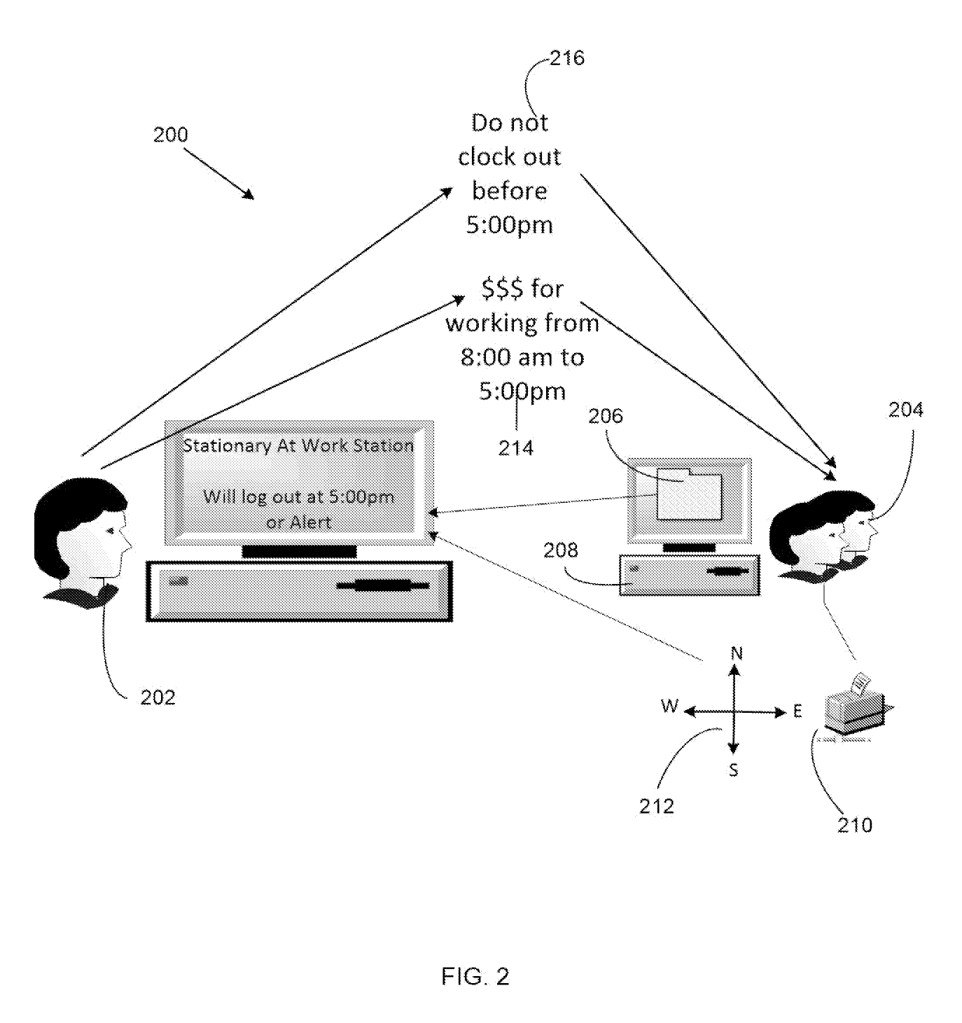

FIG. 2 illustrates a diagrammatic view of an exemplary monitoring system monitoring a location of an employee with an exemplary positioning system, in accordance with an embodiment of the present invention. In the present invention, a monitoring system 200 may create an efficient monitoring and time allotment process to enable a manager 202 to monitor an employee 204 performing a job 206, while the employee is utilizing a communication device 210. The manager may monitor movements by the employee through a positioning system 212 that integrates with the communication device. The system may utilize the positioning system to monitor the communication device. The communication device may be in proximity to the employee while the employee perform the job at a work station 208, or while the employee performs the job mobile. In this manner, the system may allow the manager to better track the movement of the employee, while having a better understanding of the status of the job. This may be important when the job is at a remote location, such as at an employee's home, or in a different country. In this manner, the manager may assess job performance and compensation for the employee, for compensation, payroll, and job reviews.

In some embodiments, the employee may perform the job at the work station through the communication device 210. The communication device may include a smart phone that is monitored by the positioning system. The manager may have access to the software and the positioning system that are integrated into the communication device. The communication device may further include a camera for recording an image of the employee performing the job. In some embodiments, the employee may be required to face the camera in proximity to the work station. The manager may be able to access the image and the information from the positioning device to monitor the location of the employee. In essence, the image and the data from the positioning system may work in conjunction to help determine the location of the employee. This may, in turn, enable the manager to generate a compensation 214 for the employee. The payroll and other accounting may also be enhanced by better understanding the location and time use by the employee.

In some embodiments, the manager may create at least one parameter 216 that sets a dictate for the employee. The parameter may be efficacious in regulating and monitoring the employee during the duration of work. The communication device may be integrated with the parameter, such that the software in the communication device may at least partially restrict the employee from performing certain functions if the parameters have been crossed. The at least one parameter may be useful in helping the manager monitor the employee and the job by forming a parameter, such as, at which location, and at what durations the employee may perform the job. For example, if the parameter requires the employee to log in at 8:00 am, the employee will not be able to log in for the job after 8:00 am. The communication device may generate an audible signal if the employee attempts to log in after 8:00 am.

In some embodiments, the at least one parameter may include a time or performance related dictate from the manager for the employee performing the job. The manager may relay the parameter to enhance communication and understanding about the job and related incidents. The at least one parameter may include, without limitation, log in time, log off time, break time, hours worked, breaks taken, overtime requests, expenses limitations for the job, success or failure of the job, and scheduling related requests. In one embodiment, the parameter of the duration of the job may be determined by the image of the employee working at the processing device, the software recording the type and amount of work performed, and the event. The manager may then be more able to provide a more accurate compensation to the employee based on this data. In this manner, payroll and bookkeeping may be improved. The system may be efficacious for monitoring the employee from a remote job site, such as a home based job, or an international company having employees far from headquarters.

In one alternative embodiment, the monitoring system may be utilized by a football coach to monitor a player on the field. The player may be restricted from blocking outside of a certain dimension on the field, wherein the coach may be alerted if the player exceeds the blocking parameter. In yet another alternative embodiment, the manager and the employee can monitor each other through a two way video display. In yet another alternative embodiment, the recorded images of the employee may be saved for providing a training video for future employees.

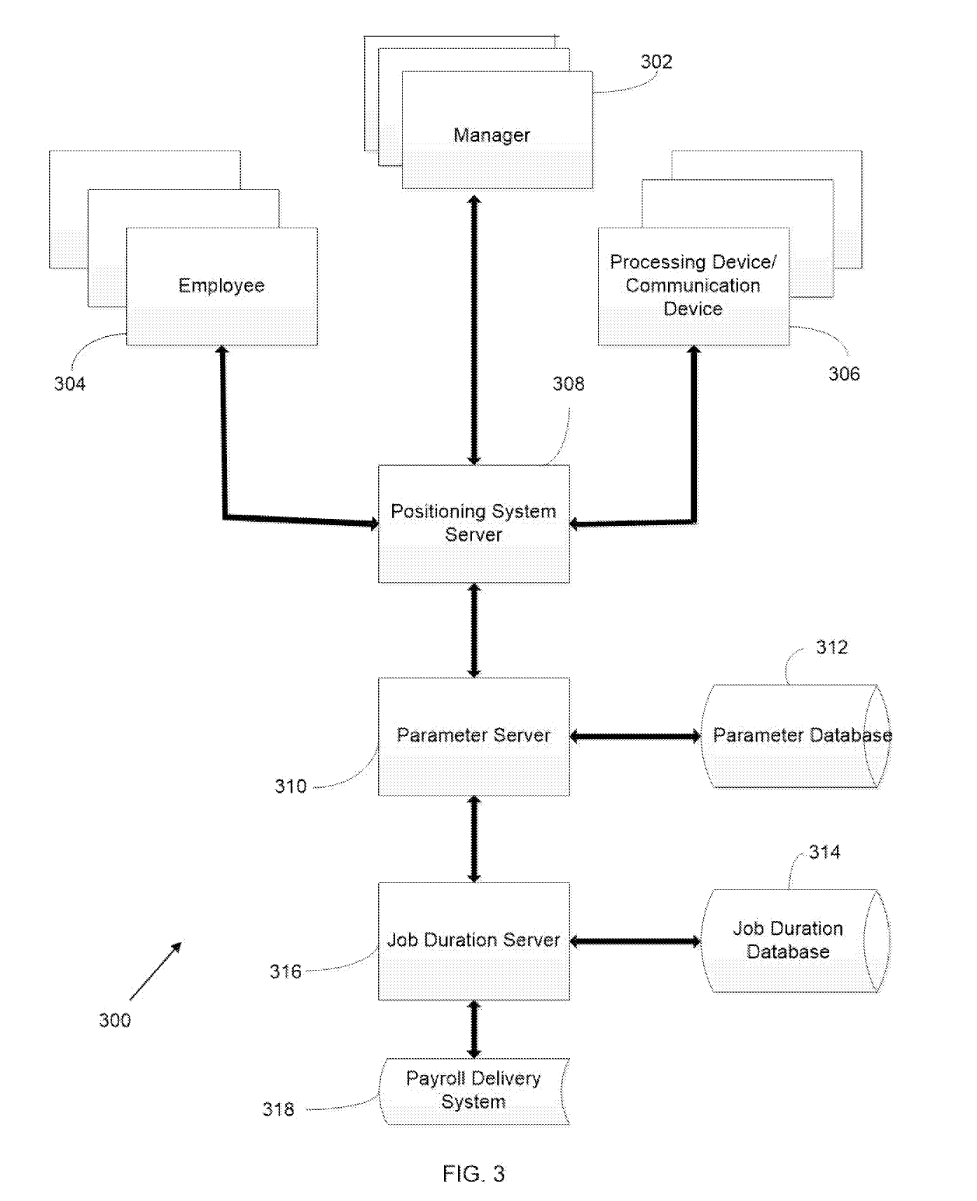

FIG. 3 illustrates a system block diagram for an exemplary monitoring system, in accordance with an embodiment of the present invention. In monitoring system 300, manager 302, employee 304, and communication device 306 communicate with positioning system server 308. Manager 302 may input employee information 304 and communication device preferences 306 into monitoring system 300 for generating a compensation. Parameter server 310 may store employee/job information 304 and communication device location 306 in parameter database 312. Job duration database 314 may store hours and days worked on job. Job duration server 316 may query appropriate job data from job duration database 314 based on employee information 304, and communication device preferences 306. Job duration server 316 may transfer job data to a payroll delivery system 318.

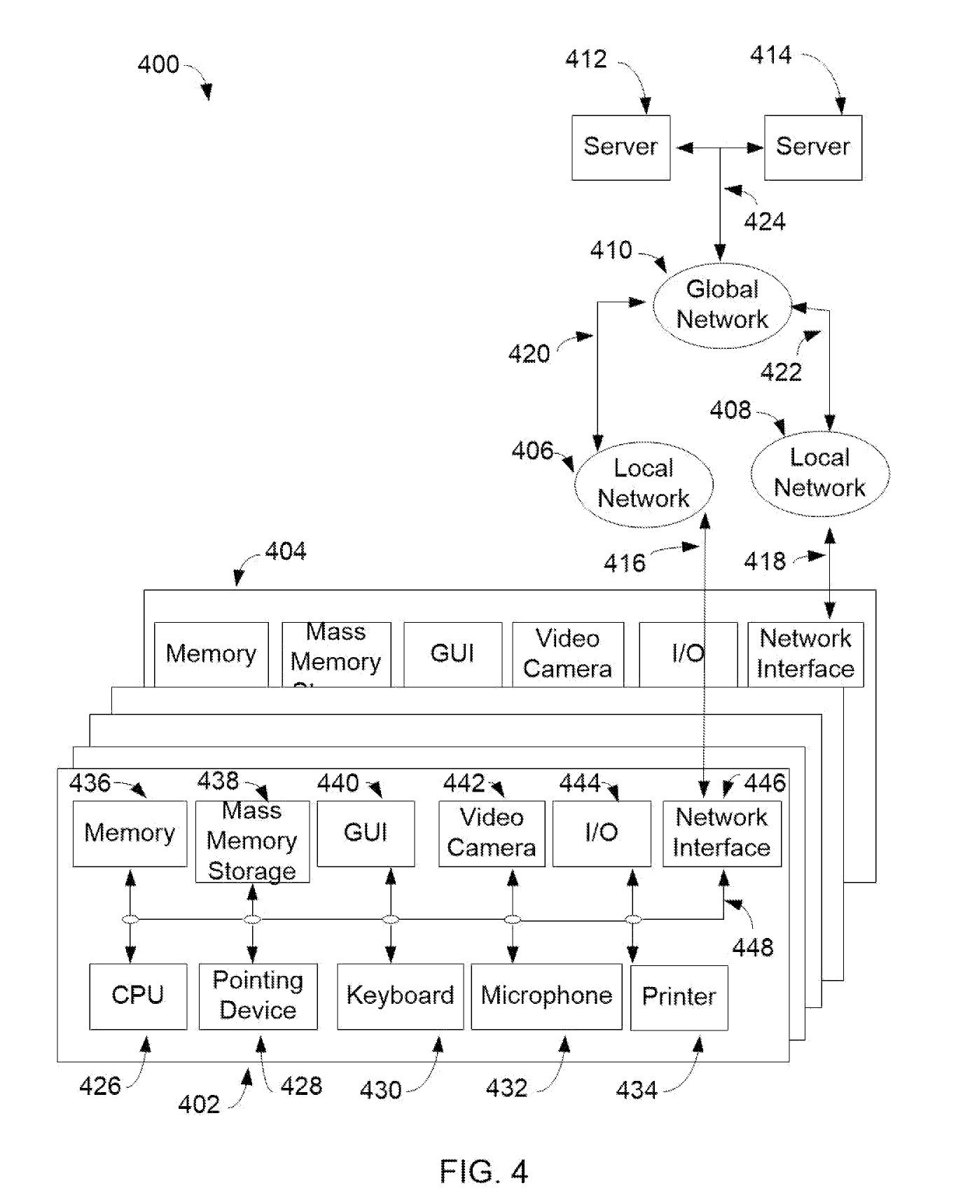

FIG. 4 illustrates a typical computer system that, when appropriately configured or designed, can serve as an exemplary management system and method for a manager to manage an employee, in accordance with an embodiment of the present invention. In the present invention, a communication system 400 includes a multiplicity of clients with a sampling of clients denoted as a client 402 and a client 404, a multiplicity of local networks with a sampling of networks denoted as a local network 406 and a local network 408, a global network 410 and a multiplicity of servers with a sampling of servers denoted as a server 412 and a server 414.

Client 402 may communicate bi-directionally with local network 406 via a communication channel 416. Client 404 may communicate bi-directionally with local network 408 via a communication channel 418. Local network 406 may communicate bi-directionally with global network 410 via a communication channel 420. Local network 408 may communicate bi-directionally with global network 410 via a communication channel 422. Global network 410 may communicate bi-directionally with server 412 and server 414 via a communication channel 424. Server 412 and server 414 may communicate bi-directionally with each other via communication channel 424. Furthermore, clients 402, 404, local networks 406, 408, global network 410 and servers 412, 414 may each communicate bi-directionally with each other.

In one embodiment, global network 410 may operate as the Internet. It will be understood by those skilled in the art that communication system 400 may take many different forms. Non-limiting examples of forms for communication system 400 include local area networks (LANs), wide area networks (WANs), wired telephone networks, wireless networks, or any other network supporting data communication between respective entities.

Clients 402 and 404 may take many different forms. Non-limiting examples of clients 402 and 404 include personal computers, personal digital assistants (PDAs), cellular phones and smartphones.

Client 402 includes a CPU 426, a pointing device 428, a keyboard 430, a microphone 432, a printer 434, a memory 436, a mass memory storage 438, a GUI 440, a video camera 442, an input/output interface 444 and a network interface 446.

CPU 426, pointing device 428, keyboard 430, microphone 432, printer 434, memory 436, mass memory storage 438, GUI 440, video camera 442, input/output interface 444 and network interface 446 may communicate in a unidirectional manner or a bi-directional manner with each other via a communication channel 448. Communication channel 448 may be configured as a single communication channel or a multiplicity of communication channels.

CPU 426 may be comprised of a single processor or multiple processors. CPU 426 may be of various types including micro-controllers (e.g., with embedded RAM/ROM) and microprocessors such as programmable devices (e.g., RISC or SISC based, or CPLDs and FPGAs) and devices not capable of being programmed such as gate array ASICs (Application Specific Integrated Circuits) or general purpose microprocessors.

As is well known in the art, memory 436 is used typically to transfer data and instructions to CPU 426 in a bi-directional manner. Memory 436, as discussed previously, may include any suitable computer-readable media, intended for data storage, such as those described above excluding any wired or wireless transmissions unless specifically noted. Mass memory storage 438 may also be coupled bi-directionally to CPU 426 and provides additional data storage capacity and may include any of the computer-readable media described above. Mass memory storage 438 may be used to store programs, data and the like and is typically a secondary storage medium such as a hard disk. It will be appreciated that the information retained within mass memory storage 438, may, in appropriate cases, be incorporated in standard fashion as part of memory 436 as virtual memory.

CPU 426 may be coupled to GUI 440. GUI 440 enables a user to view the operation of computer operating system and software. CPU 426 may be coupled to pointing device 428. Non-limiting examples of pointing device 428 include computer mouse, trackball and touchpad. Pointing device 428 enables a user with the capability to maneuver a computer cursor about the viewing area of GUI 440 and select areas or features in the viewing area of GUI 440. CPU 426 may be coupled to keyboard 430. Keyboard 430 enables a user with the capability to input alphanumeric textual information to CPU 426. CPU 426 may be coupled to microphone 432. Microphone 432 enables audio produced by a user to be recorded, processed and communicated by CPU 426. CPU 426 may be connected to printer 434. Printer 434 enables a user with the capability to print information to a sheet of paper. CPU 426 may be connected to video camera 442. Video camera 442 enables video produced or captured by user to be recorded, processed and communicated by CPU 426.

CPU 426 may also be coupled to input/output interface 444 that connects to one or more input/output devices such as such as CD-ROM, video monitors, track balls, mice, keyboards, microphones, touch-sensitive displays, transducer card readers, magnetic or paper tape readers, tablets, styluses, voice or handwriting recognizers, or other well-known input devices such as, of course, other computers.

Finally, CPU 426 optionally may be coupled to network interface 446 which enables communication with an external device such as a database or a computer or telecommunications or internet network using an external connection shown generally as communication channel 416, which may be implemented as a hardwired or wireless communications link using suitable conventional technologies. With such a connection, CPU 426 might receive information from the network, or might output information to a network in the course of performing the method steps described in the teachings of the present invention.

Those skilled in the art will readily recognize, in light of and in accordance with the teachings of the present invention, that any of the foregoing steps may be suitably replaced, reordered, removed and additional steps may be inserted depending upon the needs of the particular application. Moreover, the prescribed method steps of the foregoing embodiments may be implemented using any physical and/or hardware system that those skilled in the art will readily know is suitable in light of the foregoing teachings. For any method steps described in the present application that can be carried out on a computing machine, a typical computer system can, when appropriately configured or designed, serve as a computer system in which those aspects of the invention may be embodied. Thus, the present invention is not limited to any particular tangible means of implementation.

All the features or embodiment components disclosed in this specification, including any accompanying abstract and drawings, unless expressly stated otherwise, may be replaced by alternative features or components serving the same, equivalent or similar purpose as known by those skilled in the art to achieve the same, equivalent, suitable, or similar results by such alternative feature(s) or component(s) providing a similar function by virtue of their having known suitable properties for the intended purpose. Thus, unless expressly stated otherwise, each feature disclosed is one example only of a generic series of equivalent, or suitable, or similar features known or knowable to those skilled in the art without requiring undue experimentation.

Having fully described at least one embodiment of the present invention, other equivalent or alternative methods of implementing a management system and method that enables a manager to view an employee at a remote job site, and monitor the duration of the job according to the present invention will be apparent to those skilled in the art. Various aspects of the invention have been described above by way of illustration, and the specific embodiments disclosed are not intended to limit the invention to the particular forms disclosed. The particular implementation of the management system and method that enables a manager to view an employee at a remote job site, and monitor the duration of the job may vary depending upon the particular context or application. By way of example, and not limitation, the management system and method that enables a manager to view an employee at a remote job site, and monitor the duration of the job described in the foregoing were principally directed to a software application that monitors an image and duration of job performance by the employee; however, similar techniques may instead be applied to a warehouse distribution system where robots access and photograph purchased items prior to shipping, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Claim elements and steps herein may have been numbered and/or lettered solely as an aid in readability and understanding. Any such numbering and lettering in itself is not intended to and should not be taken to indicate the ordering of elements and/or steps in the claims.

What is claimed is:

1. One or more computer storage media storing computer-usable instructions, that when used by one or more computing devices, cause the one or more computing devices to perform a method comprising the steps of:
(a) integrating, by a manager, a positioning system with a communication device;
(b) setting at least one parameter for regulating and monitoring an employee and a job;
(c) performing, by said employee, said job with said communication device;
(d) recording an image of said employee with a camera;
(e) monitoring a position of said employee with said communication device;
(f) determining a duration for said employee performing said job; and
(g) calculating a compensation based on said duration and said at least one parameter.

2. The method of claim 1, in which said method comprises a monitoring method configured to enable said manager to monitor said employee while performing said job with a positioning system.

3. The method of claim 2, in which step (a) further comprises said manager downloading a software application onto a processing device.

4. The method of claim 3, in which step (a) further comprises said software application operatively connects with said positioning system in said communication device.

5. The method of claim 4, in which step (a) further comprises said software application recording said employee through said camera on said communication device and alerting said employee a duration of the job and a time for at least one break.

6. The method of claim 5, in which step (a) further comprises a plurality of managers monitoring the position and job performance of a plurality of employees.

7. The method of claim 6, in which said processing device comprises a computer.

8. The method of claim 7, in which step (b) further comprises said manager setting said at least one parameter to display on said communication device for viewing by said employee.

9. The method of claim 8, in which step (b) further comprises said employee performing said job within said at least one parameter set by said manager.

10. The method of claim 9, in which said at least one parameter comprises a location for said employee to perform said job and duration for said employee to perform on said job.

11. The method of claim 10, in which said communication device comprises a cellular phone.

12. The method of claim 11, wherein said camera is disposed to operatively join with said communication device.

13. The method of claim 12, in which step (d) further comprises capturing a video clip of said employee.

14. The method of claim 13, in which step (d) further comprises said employee positioning said camera at a proximal location while performing said job to capture said image.

15. The method of claim 14, in which step (d) further comprises said image being saved for a predetermined duration, and viewed at a future time.

16. The method of claim 15, in which said step (e) further comprises a positioning system on said communication device relaying said position of said employee.

17. The method of claim 16, in which said step (e) further comprises said manager communicating to said employee to continue or cease performing said job.

18. The method of claim 17, in which said compensation comprises a salary, and/or an hourly pay, and/or a bonus.

19. A system for managing comprising:
means integrating, by a manager, a positioning system with a communication device;
means for setting at least one parameter for regulating and monitoring an employee and a job;
means for performing, by said employee, said job with said communication device;
means for recording an image of said employee with a camera;
means for monitoring a position of said employee with said communication device;
means for determining a duration for said employee performing said job; and
means for calculating a compensation based on said duration and said at least one parameter.

20. A non-transitory program storage device readable by a machine tangibly embodying a program of instructions executable by the machine to perform a method for managing, the storage device comprising:
computer code for integrating, by a manager, a positioning system with a communication device;
computer code for setting at least one parameter for regulating and monitoring an employee and a job;
computer code for performing, by said employee, said job with said communication device;
computer code for recording an image of said employee with a camera;
computer code for monitoring a position of said employee with said communication device;
computer code for determining a duration for said employee performing said job; and
calculating a compensation based on said duration and said at least one parameter.
